(19) United States
(12) Patent Application Publication
(10) Pub. No.: US 2011/0193381 A1
(43) Pub. Date: Aug. 11, 2011

(54) RECLINING CHILD SEAT

(76) Inventors: JOSE SALAZAR, Corcoran, CA (US); Olga Salazar, Corcoran, CA (US)

(21) Appl. No.: 12/702,711

(22) Filed: Feb. 9, 2010

(51) Int. Cl. B60N 2/26

(52) U.S. Cl. 297/256.13

(57) ABSTRACT

A child seat for transporting a child in a vehicle comprising: a seat portion; a back portion, where said back portion is rotatably attached to the seat portion; an upright position, where said back portion is at about a 90-degree angle in related to the seat portion; and a reclined position, where said back portion is between about a 90-degree angle to a 180-degree angle in related to the seat portion. The seat portion moves in a horizontal plane to facilitate the movement of the back portion. In one exemplary embodiment, the seat portion moves horizontally forward when the back portion is placed in the reclined position and moves horizontally backward when the back portion is placed in the upright position.

### BACKGROUND OF THE INVENTION

1. Field of Invention

The present invention relates to a reclining child seat that includes a reclining mechanism to allow the seat to tilt back while an infant reclines in the seat.

2. Description of Related Art

Toddlers, infants and babies normally are transported in vehicles by placement within a specially designed child seat. The child safety seat is normally required by law and provides a means to secure the infant or baby while transporting in a vehicle. Most car seats include straps that wrap around the infant to secure the infant in the seat and a means to secure the seat into the safety belt of the vehicle's seat. A number of child safety seats remain in the upright position and do not provide a means to recline. This lack of a reclining feature may be a drawback in certain instances where an infant or baby falls asleep. Implementing a reclining child safety seat may help to place the child in a more comfortable position as opposed to remaining upright while sleeping.

Child safety seats have been designed to include reclining mechanisms. The reclining seats of the prior art have some drawbacks to them since many do not maintain a secure position when in the reclined position or require that the infant sit in a reverse or backward position in order to facilitate the reclining of the car seat. U.S. Pat. No. 6,739,661 discloses a child safety seat that pivots between a sitting and a reclining position on a base secured by a vehicle safety belt. As noted, the car seat according to the '661 patent discloses a pivoting car seat and therefore is one example of a car seat that may be required to be placed in a reverse or back facing manner in order to function properly.

### SUMMARY OF THE INVENTION

The present invention relates to a child seat for transporting a child in a vehicle comprising: a seat portion; a back portion, where said back portion is rotatably attached to the seat portion; an upright position, where said back portion is at about a 90-degree angle in related to the seat portion; and a reclined position, where said back portion is between about a 90-degree angle to a 180-degree angle in related to the seat portion. The seat portion moves in a horizontal plane to facilitate the movement of the back portion. In one exemplary embodiment, the seat portion moves horizontally forward when the back portion is placed in the reclined position and moves horizontally backward when the back portion is placed in the upright position.

### BRIEF DESCRIPTION OF DRAWINGS

FIG. 1 depicts a reclining child seat according to the present invention.

### DETAILED DESCRIPTION

The present invention provides a reclining child safety seat that provides a means to recline and place the child in a more relaxed position when the infant falls asleep while transporting them in a vehicle. The child seat according to present invention provides this reclined position so that a child may recline on their back during sleep and avoid a slumped over position when the seat is in the upright position. The reclining car seat according to present invention enables the child to be placed in a more comfortable position and to alleviate any neck cramping or pain that may inadvertently occur when the child is sleeping in the upright position.

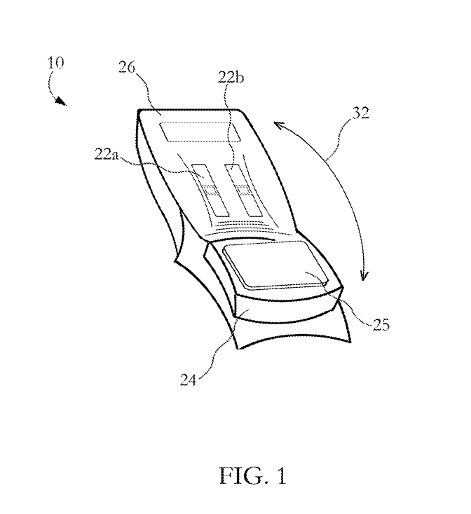

A child Seat 10 is depicted in FIG. 1 in accordance with the present invention. The child Seat 10 includes a Seat Portion 24 and a Back Portion 26. The seat portion 24 and back portion 26 are joined in order to form the overall composition of the reclining Seat 10. Straps 22(a), 22(b) are provided to secure the infant into the seat during use thereof. The Back Portion 26 reclines over a Range of Motion 32. The range of motion 32 provides a range of reclining moving the car seat from an upright position to a reclined position as desired. When the Car Seat 10 is in a completely reclined position, the Back Portion 26 is reclined to about a 180-degree angle in relation to the Seat Portion 24. The Seat Portion 24 moves in a horizontal direction in order to facilitate the reclining of the Back Portion 26, forward when the Back Portion 26 is reclined and backward when the Back Portion is placed in an upright position. The Back Portion 26 may be elevated to an upright position where the Seat Portion 24 and Back Portion 26 may be positioned at about a 90-degree angle between them. The Back Portion 26 may be locked at any angle between the 90-degree position (upright) and 180-degree position (completely reclined). Placing the Seat 10 in a reclining position makes sleep easier for the child or infant that may be in the child seat. The child Seat 10 according to the present invention also includes a removable Table 25 that may be used by the infant while in the child Seat 10.

The child seat according to the present invention provides a practical seat that reclines and places the infant in a reclined position while sleeping. This reclined position helps the infant to remain sleeping and enjoy a comfortable sleep without neck pain that may occur when the seat is in the upright position. The instant invention has been shown and described in what it considers to be the most practical and preferred embodiments. It is recognized, however, that departures may be made there from within the scope of the invention and that obvious modifications will occur to a person skilled in the art.

What is claimed is:

1. A child seat for transporting a child in a vehicle comprising:
a. a seat portion;
b. a back portion, where said back portion is rotatably attached to the seat portion;
c. an upright position, where said back portion is at about a 90-degree angle in related to the seat portion; and
d. a reclined position, where said back portion is between about a 90-degree angle to a 180-degree angle in related to the seat portion.

2. The child seat according to claim 1, where the seat portion moves in a horizontal plane.

3. The child seat according to claim 2, where the seat portion moves horizontally forward when the back portion is placed in the reclined position and moves horizontally backward when the back portion is placed in the upright position.
